(19) United States
(12) Patent Application Publication
(10) Pub. No.: US 2007/0111162 A1
(43) Pub. Date: May 17, 2007

(54) Tooth implant

(76) Inventor: Robert Laux, Sulzbach/Murr (DE)

Correspondence Address: KLAUS J. BACH, 4407 TWIN OAKS DRIVE, MURRYSVILLE, PA, 15668, US

(21) Appl. No.: 11/580,710

(22) Filed: Oct. 13, 2006

Related U.S. Application Data
(63) Continuation-in-part of application No. PCT/EP05/03834, filed on Apr. 12, 2005.

(30) Foreign Application Priority Data
Apr. 14, 2004 (DE) 10 2004 018 512.3

(51) Int. Cl. A61C 8/00

(52) U.S. Cl. 433/173

(57) ABSTRACT

In a tooth implant for mounting onto an implant base carrier (2), including a support post and a crown releasably disposed on the support post, wherein the support post has a cone-shaped base body with at least a friction cone sector and an accommodation sector which, with respect to a rotationally symmetrical enveloping area as defined by the cone sector, forms a cavity under the crown upper and lower edge areas where the crown is in contact with the base body, the friction cone sector and a connecting line extending between upper and lower edge areas of the accommodation sector have, in a plane receiving the longitudinal axis of the support post, different inclination angles with respect to the longitudinal axis of the support post.

This is a Continuation-In-Part Application of International Application PCT/EP2005/003834 filed Apr. 12, 2005 and claiming the priority of German Application 10 2004 018 512.3 filed Apr. 14, 2004.

### BACKGROUND OF THE INVENTION

The invention relates to a tooth implant including primary and secondary crown parts which are releasably joined and one is in the form of a cone-shaped support post including a friction cone section.

WO 01/50977 A1 discloses a tooth implant which comprises a base carrier member which is to be implanted into the jaw of a patient and onto which a support post is mounted which carries the tooth crown. The support post comprises two parts, an upper post part and a lower post part, and the two post parts are separated by way of inclined separation plane which defines with the longitudinal axis of the support post an angle different from 90°. The two post parts can be combined in different angular positions with respect to the longitudinal axis of the support post. Because of the inclined separation plane between the two post parts, different angular orientations can be obtained depending on the angular position of the upper post part relative to the lower post part.

The crown to be disposed on the upper post part assumes the same orientation as the upper post part which has the advantage that the crown can be adapted to the individual conditions in the mouth of a patient.

It is to be taken into consideration however that an inclination of the support post requires also an inclined mounting of the upper post part but that, particularly because of the adjacent teeth the spaces are often very tight and permit only relatively small angle deviations from the central axis.

DE 41 41 128 C2 discloses a dental implant with a base carrier and a support post which carries a secondary crown. The support post has a conical shape and the secondary crown is provided with a complementary inner cone shape which, in the installed position abuts the outer surface of the support post. In order to be able to provide a common insertion direction for the interconnected double crowns with two contiguous tooth implants, the support post includes an internal bore which is inclined with respect to the longitudinal axis of the support post and can be placed onto a screw extending in the longitudinal direction of the base carrier for firm connection to the base carrier. By rotation of the support post the desired angular position can be adjusted.

However, the later removal of the support post from the base carrier and its re-installation is problematic since the accurate angular position of the support post has to be re-established. Because of the conical shape of the support post, the secondary crown cannot be moved in insertion direction even if there is only a small deviation from the optimal angular position.

DE 41 10 789 A1 discloses a tooth implant with an inner cone element whose outer surface forms a friction surface for a secondary sleeve to be disposed thereon. Between the base carrier to be implanted into the jawbone and the tooth top there or a lower support post (or respectively, a primary crown) and a secondary crown disposed thereon, wherein the secondary crown carries the tooth structure.

Different angular positions must be realized in the arrangement of DE 41 10 789 Al by means of an inclined area on the base carrier on which the support post is mounted. This means that already the relatively deep seated mounting post assumes very different angular positions with respect to the base carrier disposed in the jaw bone whereby, as a result, those angular positions deviating from a vertical cause a transverse displacement which increases with the height.

U.S. Pat. No. 5,439,380 discloses implant parts which comprise a base carrier which is to be implanted into the jaw of a patient and onto which a support post is mounted which carries a tooth crown. The support post may be mounted to the base carrier so as to extend therefrom at different angles in order to establish different angle configurations between the longitudinal axes of the base carrier and the support post and as a result, also the tooth crown. The support post is screwed onto the base carrier for which purpose the support post is in the form of a sleeve with an axial through bore into which the screw is inserted.

In the arrangement according to U.S. Pat. No. 5,439,380, it is disadvantageous that there are only six angular position at angular distances of 60°, which are determined by a hexagonal connection between the support post and an underlaying hexagonal connecting part.

The support post surface has a conical configuration so that the tooth crown can be firmly placed onto the support post and cemented thereto. During cementing however a jointure gap is formed in which deposits may be collected.

It is the object of the present invention to provide a tooth implant which, even with an angled position of the tooth implant permits a vertical mounting and removal of one implant part with respect to another implant part.

### SUMMARY OF THE INVENTION

In a tooth implant for mounting onto an implant base carrier (2), including a support post and a crown releasably disposed on the support post, wherein the support post has a cone-shaped base body with at least a friction cone sector and an accommodation sector which, with respect to a rotationally symmetrical enveloping area as defined by the cone sector, forms a cavity under the crown upper and lower edge areas where the crown is in contact with the base body, the friction cone sector and a connecting line extending between upper and lower edge areas of the accommodation sector have, in a plane receiving the longitudinal axis of the support post, different inclination angles with respect to the longitudinal axis of the support post.

Furthermore, the second sector differs in its shape and/or its location from the friction cone sector with respect to the longitudinal axis of the base body. The second sector includes a recess which, with respect to a cone-shaped rotationally symmetrical enveloping surface area of the friction cone sector is displaced either inwardly or outwardly depending on whether the component which includes the two different sectors is surrounded or disposed around the component. Because of this recess the enveloping are extends at n angle with respect to the longitudinal axis of the base body which is different from the angle between a line extending between the upper and lower edges of the cavity and the longitudinal axis of the base body.

If the part with the two different sectors is surrounded by the second part, the cavity is disposed between the longitudinal axis of the base carrier and the cone-shaped rotationally symmetrical envelope defined by the friction cone sector. The second sector is recessed in the longitudinal direction with respect to the envelope defined by the friction cone sector, whereby the cavity is formed. This cavity makes it possible to install and remove the implant part cooperating with the first implant part in a direction which deviates from the longitudinal axis of the first implant part. The installation or, respectively, removal direction of the second implant part does not need to coincide with the longitudinal axis of the second implant part either.

The cavity in the area of the second sector which has the function of a accommodation sector is formed for example by providing in this second sector in the area of the lower base carrier edge a recess which extends in the direction of the longitudinal axis whereby a lower shoulder is formed on the second sector. In this embodiment, the lower shoulder has in the area of the second sector the same radius as in the area of the first sector which is in the form of a friction sector. However, the lower base carrier edge may have a smaller radius in the area of the second sector than in the area of the first sector.

The cavity may also be obtained in that the second sector is recessed in the area of the upper edge the support post and has a smaller radius than the angle segment of the first sector.

With a recessed lower and upper support post edge in the area of the second sector, both sectors may have inclination angles of the same size with respect to the longitudinal axis of the support post. In accordance with another advantageous embodiment, the envelope surface of both sectors may have different angles with respect to the longitudinal axis. In that case, the different inclination angles permit an installation and removal of the second implant part (the crown) cooperating with the first implant part (the support post) in a direction which is different from the direction of the longitudinal axis of the first implant part, that is the support post.

Because of the cavity provided in the area of the second sector, tooth implant base carriers can be installed into the jaw of a patient in a slanted position while, instead of the slanted position of the base body, at least the crown can be installed on the implant in a vertical position or, respectively, a support post can be installed vertically on the base body and can be removed therefrom. Collisions with adjacent teeth do not occur.

Another advantage is that also with a subsequent change of the tooth implant for example if the crown or the support post become unintentionally loose, the desired installation position can be re-established at any time without substantial additional efforts. On one hand, a very accurate re-orientation of the crown after removal and re-installation is possible but, on the other hand, not absolutely necessary for a secure connection while maintaining an angle divergence between the longitudinal implant axis and the installation direction since each sector extends over a larger circumferential angle so that, with a position change of the crown of only a few degrees, a collision-free installation of the crown is generally still possible.

Basically, two different implant parts can be removably joined by means of different sectors on one of the two implant parts in a force-locking manner, wherein, also if one of the implant parts is inclined, the respective other implant part is mounted vertically or, respectively, straight and is removable in this direction. The implant part with the two different sectors can be arranged on the end adjacent the jaw of the patient or at the end remote from the jaw.

The implant part provided with different sectors is expediently a support post of a tooth implant which is arranged between a base carrier to be implanted into the jaw and a secondary crown disposed in the visible area of the tooth implant wherein the secondary crown represents the second implant part which can be mounted onto the support post at an angle different from that of the longitudinal axis of the support post.

Vice versa, the implant part including the two different sectors may also be the secondary crown, which is mounted onto the support post.

The implant part, particularly the support post may include in a front area an axially projecting multi-edge connecting section for example a hexagonal connecting section which can be inserted into a complementarily shaped recess in the adjacent component of the tooth implant—usually in the base carrier. This multi-edge connection provides only for a limited number of angular positions of the respective implant part wherein the number of angular positions depends on the number of edges of the multi-edge connecting section. In the exemplary embodiment of a hexagon, the respective implant can be installed in six different angular positions which differ by 60°. In case of a subsequent machining of the tooth implant for which the tooth implant needs to be removed, it can easily be re-installed in the desired angular position since the asymmetric shape provided by differently shaped sectors in the support post of the implant offers sufficient reference points for re-installation in the correct 60° angle position.

One of the sectors has the function of a friction cone sector which has a conical geometry with a cone angle which is expediently in a range of 1° to 9°, particularly about 4°. The friction cone sector provides for a frictional jointure with the adjacent implant part which includes a complementary abutment surface which engages the friction cone sector and forms a frictional jointure therewith. Expediently, the friction cone sector extends in circumferential direction at least over 180° of the support post so as to provide for a sufficiently large frictional area and, consequently, a jointure with a sufficiently large engagement force.

The second sector has the function of an accommodation sector which, because of its different inclination angle facilitates the accommodation of an angle divergence between the longitudinal axis of the base body and the installation or, respectively, removal direction.

This accommodation sector may, in a first advantageous embodiment, also have a conical geometry wherein the inclination angle may be larger or smaller than the inclination angle of friction cone sector. Expediently, however, the inclination angle is larger and is in a range of 15° to 20°.

In accordance with a second alternative advantageous embodiment, the accommodation sector is cylindrical so that the surface area of the accommodation sector extends parallel to the longitudinal axis of the support post.

For accommodating the angle divergence between the installation direction and the longitudinal axis of the implant, the angle difference between the two sectors is important. If for example, the inclination angle of the friction cone sector is 4° and the inclination angle of the also cone-shaped accommodation sector is 15°, then, in comparison with a rotational symmetric arrangement with a uniform 4° inclination angle a accommodation of additional 11° angle inclination is possible. In a rotational symmetrical embodiment with a uniform inclination of 4°, an angular divergence with respect to the longitudinal axis of only 4° would have to be accommodated. With the implant part according to the invention, however, at a 4° inclination angle of the friction cone sector and a 15° inclination angle of the accommodation sector, the insertion angle may differ by up to 19°.

Both sectors may extend in axial direction from an upper edge of a base body part of the support post to the lower base body edge. They may also extend only partially over an axial section of the base body part. Each sector consequently may extend over the whole axial length of the base body part or only over a part section of the base body part and also mixed arrangements are possible wherein one sector extends over the full length and an adjacent sector extends only over a partial length.

It is advantageous if, in the transition area between adjacent sectors, an axially extending groove is provided which is curved in a manner opposite to the respective adjacent sectors. This groove or, respectively, these two grooves form in the area of the two transitions between the sectors a recess which provides for additional support for the implant part being installed.

Preferably, the support post is provided within the tooth implant with a base body which has at least two sectors. But it may also be expedient if the support post is of a rotational symmetrical shape and the crown to be mounted onto the support post is provided in the area of its cavity with two sectors of different inclination angles.

The invention will become more readily apparent from the following description thereof on the basis of the accompanying drawings.

### BRIEF DESCRIPTION OF THE DRAWINGS

FIG. 1 is a cross-sectional view of a tooth implant with a base carrier to be implanted into the jaw of a patient, a support post mounted onto the base carrier by a screw wherein the mounting post includes two sectors with different inclination angles, and a tooth crown mounted onto the support post.

FIG. 2 shows a combination of two spaced implant parts which are joined by a bridge and whose longitudinal axes are arranged at inclined angles relative to one another.

FIG. 3 is a perspective view of support post having two different sectors which are both conical but each of which has a different inclination angle,

FIG. 4 is a cross-sectional view of the support post of FIG. 3 with a crown disposed thereon,

FIG. 5 shows another embodiment of a support post with a cylindrical accommodation sector on the base body of the support post,

FIG. 6 is a cross-sectional view of the support post according to FIG. 5 with a crown disposed thereon,

FIG. 7 shows a support post with a groove-shaped axially extending transition area between adjacent sectors,

FIG. 8 is a top view of a support post according to FIG. 7,

FIG. 9 shows another embodiment of a support post wherein the two sectors extend axially only over a part of the support post,

FIG. 10 shows still another embodiment of a support post with a accommodation sector which extends only over part of an axial section but the friction cone sector extends over the full axial length of the base body of the support post,

FIG. 11 is a top view of a support post wherein one segment of the accommodation sector is cut out so that the base body of the mounting post has a steep flat surface in the form of an inclined plane,

FIG. 12 is a cross-sectional view of a rotationally symmetrical support post with a crown disposed thereon whose cavity has two different sectors,

FIG. 13 is a top view of two spaced implant parts whose friction cone sectors are disposed on opposite sides, and each of the friction cone sectors extends over an angular area of the support post which is smaller than 180°,

FIG. 14 shows still another embodiment of a support post wherein the accommodation sector at the base body of the support post has the same inclination angle as the friction cone sector but is recessed with respect to an envelope surface of the friction cone sector,

FIG. 15 is a cross-sectional view of the support post according to FIG. 14 with a crown disposed thereon, and

FIG. 16 is a cross-sectional view of a support post according to FIG. 14 without a crown disposed thereon.

### DESCRIPTION OF THE VARIOUS EMBODIMENTS

Identical components are designated in the various figures by the same reference numerals.

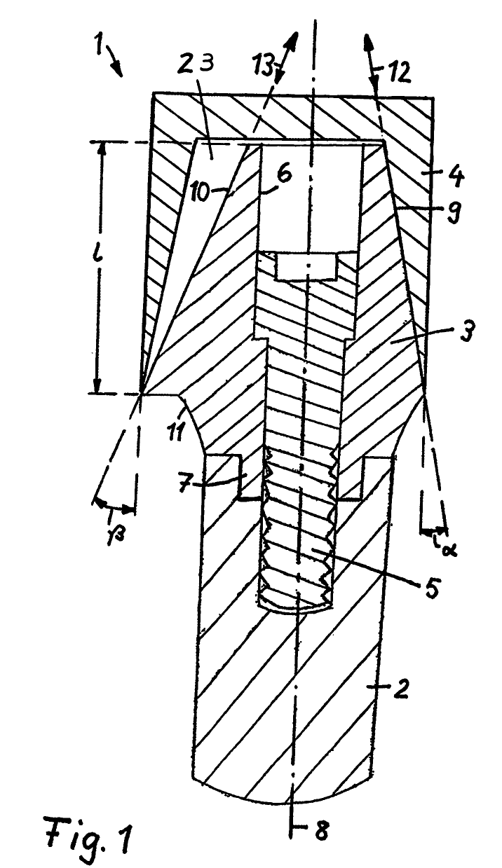

FIG. 1 shows a tooth implant 1 which comprises a base carrier 2 to be implanted into the jaw of a patient, a support post 3 and a tooth crown 4 disposed on the support post. All components have a common longitudinal axis 9. The support post 3, which is also called the primary crown is disposed on the base carrier 2 and firmly connected thereto by a screw 5. The screw 5 extends into a central bore 6 in the support post 3 and is screwed into a threaded complementary bore formed in the base carrier 2. For better mounting the support post 3 has in the area of its lower front end, a multi-edge connecting section 7, preferably in the form of a hexagonal connecting section, which is received in a complementary cavity formed in the adjacent top end of the base carrier 2. The connecting section 7 may also be in the form of a cone-shaped or cylindrical projection.

The crown 4 is connected to the support post 3 in a force locking, particularly a friction-locking manner. The crown 4 has a rotation-symmetrical shape. The support post 3 has a geometry which is not rotation-symmetrical but has in particular two sectors 9 and 10 which each extend in circumferential direction over a partial area. One (9) of the sectors, 9, 10 is a friction cone sector and the other (10) is an accommodation sector. The friction cone sector 9 has a conical shape whereas the accommodation sector 10 may also be of conical shape but may alternatively have a different shape. In FIGS. 1 to 4, the accommodation sector 10 is shown in a conical form.

Axially both sectors 9 and 10 extend over the full length of the base body part of the support post which extends from the front end thereof adjacent the crown 4 to the socket section 11 and has the length 1. The outer surface areas of the two sectors 9 and 10 extend with respect to the longitudinal axis 8 at different angles. The angle a of the friction cone sector 9 is expediently in an angle range of between 1° and 9°. It may be for example 4°. The angle β formed between the outer surface area of the accommodation sector 10 and the longitudinal axis 8 has a greater value and is preferably between 15° and 20°.

In accordance with the angles α and β of the friction cone sector 9 and, respectively, the accommodation sector 10 also the installation and removal directions for the crown 4 onto, and respectively from, the support post 3 are predetermined as indicated by the arrows 12 and 13. The installation and removal directions can be different from the longitudinal axis 8 maximally by an angle α at one side and not more than the angle β at the opposite side as indicated by the arrow 13. Of course, all intermediate position between the angles as indicated by the arrow directions 12 and 13 are possible particularly also an installation and removal direction parallel to the longitudinal axis 8.

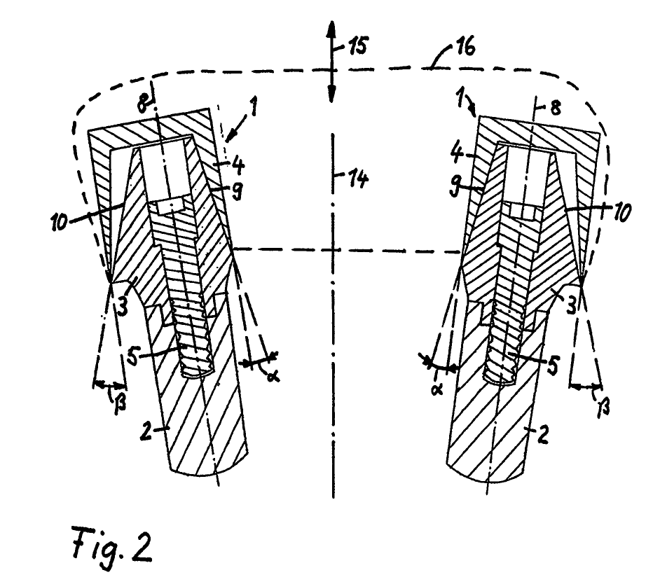

FIG. 2 shows a combination of two tooth implants 1 which have crowns 4 which are interconnected via a common bridge 16 by which they are joined. The longitudinal axes 8 of the two tooth implants are each disposed at an angle with respect to a vertical line 14 which may differ from one another. The accommodation sectors 10 at the respective mounting posts 3 are disposed at opposite outwardly facing sides, whereas the friction sectors 9 are arranged at facing sides. Because of this configuration, a bridge or a prosthesis 16 formed in this way can be installed or removed in spite of the inclined position of the two tooth implants 1—including the crowns attached to the bridge—in the direction of the arrow 15 that is, parallel to the vertical line 14. The two tooth implants 1 may be inclined with respect to the vertical line 14 maximally by the angle β which defines the inclination angle between the outer surface of the accommodation sector and the longitudinal axis 8 of the tooth implant.

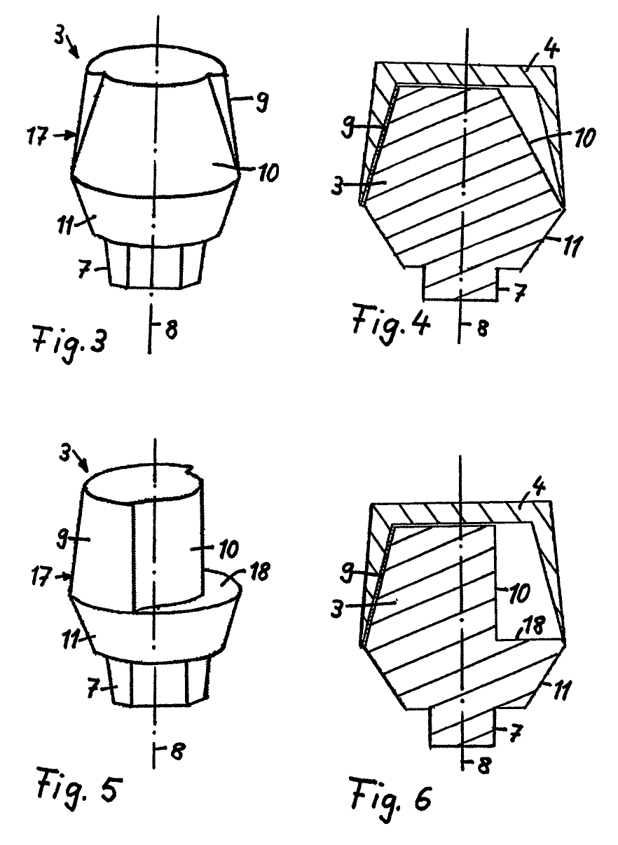

FIG. 3 shows the support post 3 in a perspective view. The two sectors 9 and 10 extend over the axial length of the base body 17, which, in the lower area of the socket part 11 is connected to the multi-edge connecting section 7. As apparent from the respective cross-sectional view of FIG. 4, which additionally shows a crown disposed on the support post, there is a wedge-like gap between the outer surface area of the accommodation sector 10 and the facing inner surface area of the crown cavity—as shown in the cross-sectional view—which is the result of the rotational symmetrical configuration of the crown 4 corresponding to the friction cone sector 9, this angle being steeper than the angle of the accommodation sector wall 10.

The embodiment of FIGS. 5 and 6 corresponds essentially to that of FIGS. 3 and 4 except that the accommodation sector 10 has a cylindrical wall whereby a shoulder 12′ is formed on the upper front side of the socket section 11. The diameter of the cylindrical accommodation sector 10 is smaller than the smaller cone diameter of the friction cone sector 9 at the front end of the support post.

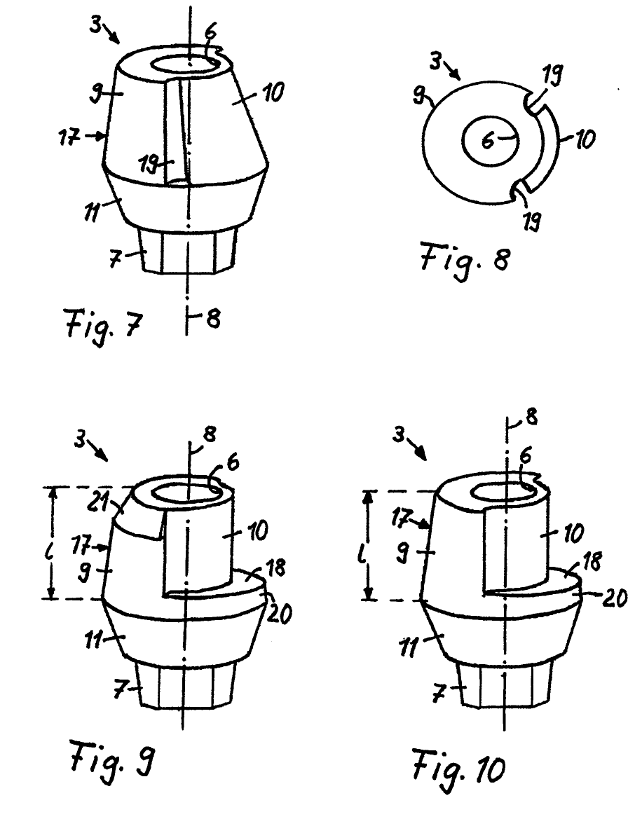

FIGS. 7 and 8 show another embodiment of a support post 3 wherein, in the transition between the friction cone sector 9 and the accommodation sector 10, an axially extending groove 19 is provided so that a recess is formed which results in better engagement of the crown mounted on the support post 3. The groove 19 has s curvature opposite to that of the sectors 9 and 10 and receives an inner surface area of the crown which has a shape complementary to that of the groove 19.

In the embodiment of the mounting post as shown in FIG. 9, the sectors 9 and 10 do not extend over the full axial length of the base body 17, but only over part thereof. The full length of the base body 17 is indicated by the distance 1. The sector 9 extends from the lower section of the base body 17 only over a partial length of the base body 17 and is provided at its upper end with a transition section 21 having an inclined surface area.

Also, the accommodation sector 10 extends only over a partial area of the base body 17. At the lower end of the accommodation sector 10, the base body 17 includes a transition section 20 forming a shoulder 18 from which the transition sector extends to the upper end of the base body 17 and has the shape of a cylinder.

FIG. 10 corresponds essentially to FIG. 9 except that the friction cone sector 9 extends over the full axial length 1 of the base body 17, whereas the cylindrical accommodation sector 10 extends, like in FIG. 8, only over a partial axial length of the base body.

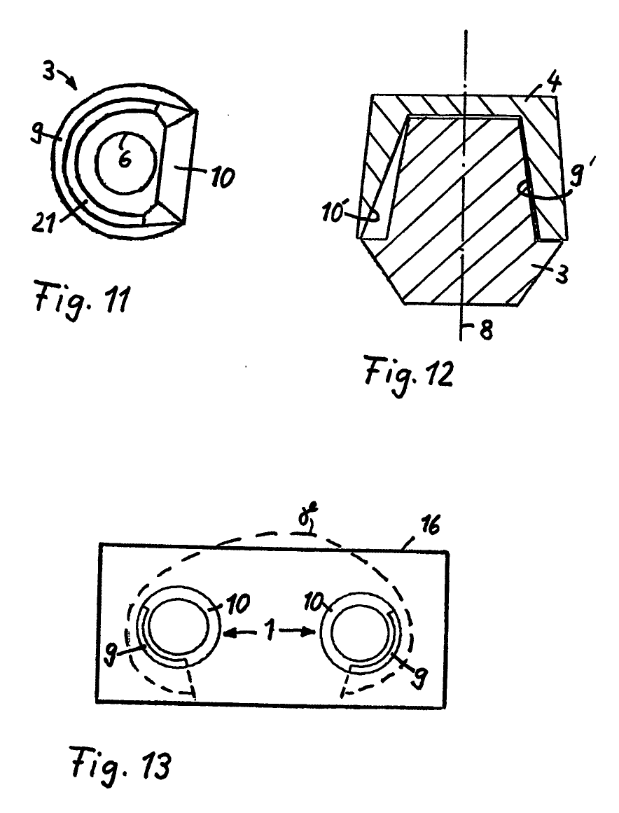

In the embodiment shown in FIG. 11, the accommodation sector is formed by an inclined planar area which is obtained by cutting a segment off the support post to form the accommodation sector. As a result, the support post 3 has no longer a circular cross-section since the accommodation sector is delimited by a plane.

In the embodiment of FIG. 12, the crown 4 has at its inner surface two different sectors 9′, 10′ whereas the support post 3 is formed rotationally symmetrical with respect to the longitudinal axis 8 thereof. With this configuration basically the same effect can be achieved as with the preceding examples.

As shown in FIG. 13, with a combination of two individual tooth implants 1, which are coupled by a bridge or prosthesis 16, it is sufficient to provide friction cone sectors 9 at the remote sides of the respective support posts, wherein each friction cone sector extends over an angular area of less than 180° in the circumferential direction of the respective support post. However because of the connection via the common bridge or prosthesis 16 a theoretical envelope for the two implants 1 which extends over the respective friction sectors 9 includes an angle γ of more than 180°. Because of such an enclosure extending over more than 180°, a firm connection between the bridge or prosthesis 16 or, respectively, the crowns connected thereto and the underlying support posts of the two tooth implants is established.

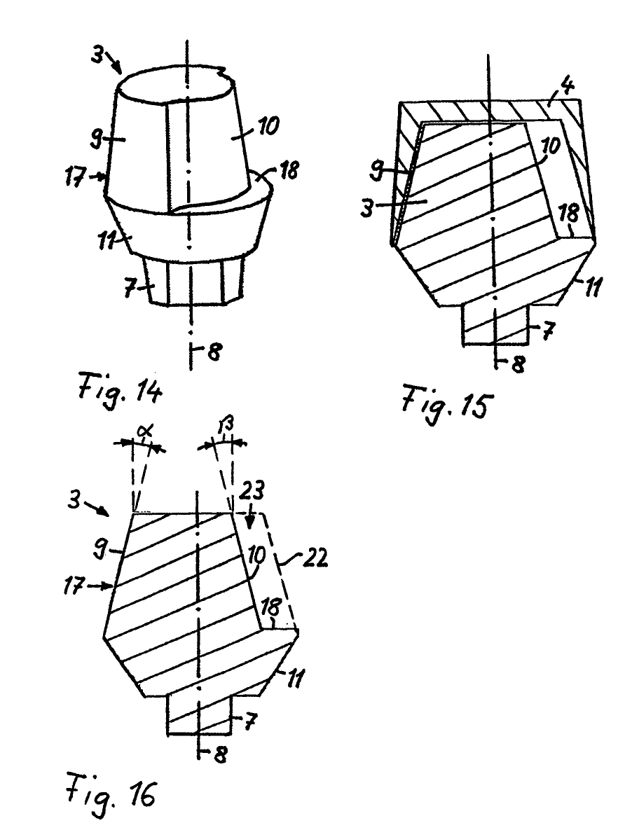

FIGS. 14-16 show another embodiment for a mounting post 3. In this embodiment, the accommodation sector 10 has the same angle of inclination β with respect to the base body axis 8 as the friction cone sector 9 with the angle a. This configuration is obtained in that the accommodation sector 10 is recessed in the area of the lower base body edge and also in the area of the upper base body radially inwardly toward the base body axis 8. In this way, a cavity 23 is formed between the outer surface area of the accommodation sector 10 and an envelope 22 defined by the surface area of the friction cone sector 9. The envelope 22 has the same cone shape as the friction sector 9. Because the inclination angles α and β of the friction cone sector 9 and of the accommodation sector 10 are the same, the latter is recessed to the same extent in the area of the upper base body edge and in the area of the lower base body edge adjacent the socket section 11 with respect to the envelope 22.

Alternatively, the recess amount of the accommodation sector 10 with respect to the envelope 22 in the upper and lower areas may be different. Then of course, the inclination angles α and β assume different values. However, different inclination angles α and β are acceptable as long as a cavity 23 remains between the envelope 22 and the surface of the accommodation sector 10.

What is claimed is:

1. A tooth implant for mounting onto an implant base carrier (2), comprising: a support post (3) and a crown (4) releasably disposed on the support post (3), said support post (3) including a cone-shaped base body (17) having a longitudinal axis (8), at least a friction cone sector (9) of conical shape and an accommodation sector (10) which, with respect to a rotationally symmetrical enveloping area (22) as defined by the friction cone sector (9), forms a cavity (23) having upper and lower edges with regard to the accommodation sector (10), said enveloping area (22) defined by the wall of the friction cone sector (9) and a connecting line extending between the upper and lower edges of the cavity (23) having, in a plane receiving the longitudinal axis (8), different inclination angles with respect to the longitudinal axis (8).

2. A tooth implant according to claim 1, wherein the accommodation sector (10) is recessed adjacent the lower edge toward the longitudinal axis (8) so as to form on the accommodation sector (10) a lower shoulder (18).

3. A tooth implant according to claim 1, wherein the accommodation sector (10) is recessed at the upper edge area toward the longitudinal axis (8).

4. A tooth implant according to claim 1, wherein the outer surfaces of the two sectors (9, 10) have the same inclination angle with respect to the longitudinal axis (8).

5. A tooth implant according to claim 1, wherein the outer surfaces of the two sectors (9, 10) have different inclination angles with respect to the longitudinal axis (8).

6. A tooth implant according to claim 1, wherein the friction cone sector (9) extends circumferentially at least over 180° of the base body (17).

7. A tooth implant according to claim 1, wherein the inclination angle (α) of the friction cone sector (9) with respect to the longitudinal axis (8) is between 1° and 9°.

8. A tooth implant according to claim 7, wherein the inclination angle (α) of the friction cone sector (9) is 4°.

9. A tooth implant according to claim 1, wherein the accommodation sector (10) has a conical shape.

10. A tooth implant according to claim 9, wherein the accommodation sector (10) has an inclination angle (β) with respect to the longitudinal axis (8) which is greater than that of the friction sector.

11. A tooth implant according to claim 10, wherein the inclination angle (β) of the accommodation sector with respect to the longitudinal axis (8) is between 15° and 20°.

12. A tooth implant according to claim 1, wherein the accommodation sector (10) includes a cylindrical wall area of the base body (17) which extends parallel to the longitudinal axis (8).

13. A tooth implant according to claim 1, wherein at least one of the sectors (9, 10) extends in axial direction from an upper edge of the base body (17) to a lower edge thereof.

14. A tooth implant according to claim 1, wherein at least one of the sectors (9, 10) extends axially only over part of the base body (17).

15. A tooth implant according to claim 1, wherein in a transition area between the two sectors (9, 10) an axially extending groove (19) is provided.

16. A tooth implant according to claim 1, wherein at a front end of its base body (17) the support post (3) is provided with an axially projecting multi-sided connecting section (7).

17. A tooth implant according to claim 1, wherein the crown (4) is disposed in close frictional engagement with the friction surface of the friction sector (9) of the support post (9).

18. A tooth implant according to claim 17, wherein the crown (4) has a rotationally symmetrical shape.

19. A tooth implant according to claim 1, wherein the crown (4) abuts the support post (3) over an area of the accommodation sector (10).

20. A combination of two spaced implants according to claim 1, wherein the friction cone sectors of the two support posts (3) within an envelope (16) extending around the two support posts extend over an angular area larger than 180°.
